(19) United States
(12) Patent Application Publication
(10) Pub. No.: US 2010/0088528 A1
(43) Pub. Date: Apr. 8, 2010

(54) METHOD AND APPARATUS FOR TAMPER-PROOF WIRTE-ONCE-READ-MANY COMPUTER STORAGE

(76) Inventor: Radu Sion, Sound Beach, NY (US)

Correspondence Address: THE FARRELL LAW FIRM, LLP, 290 Broadhollow Road, Suite 210E, Melville, NY, 11747, US

(21) Appl. No.: 12/598,726

(22) PCT Filed: May 5, 2008
(86) PCT No.: PCT/US08/62664

§ 371 Date: Nov. 3, 2009

Related U.S. Application Data
(60) Provisional application No. 60/927,438, filed on May 3, 2007.
(60) Provisional application No. 60/930,090, filed on May 14, 2007.

(51) Int. Cl. G06F 21/00; G06F 11/30; G06F 17/00

(52) U.S. Cl. 713/193; 713/194

(57) ABSTRACT

Disclosed is a method for storing digital information for storage in an adversarial setting in which trusted hardware enforces digital information compliance with data storage mandates. Secure storage overhead is minimized by identifying sparsely accessing the trusted hardware based on data retention cycles. Data retention assurances are provided for information stored by a Write-Once Read-Many (WORM) storage system.

### PRIORITY

This application claims priority to U.S. Provisional Application No. 60/927,438, filed May 3, 2007, and to U.S. Provisional Application No. 60/930,090, filed May 14, 2007, the contents of each of which is incorporated herein by reference.

### GOVERNMENT SUPPORT

The invention was supported, in part, by award CNS-0627554 from the National Science Foundation. The U.S. Government may have certain rights in the invention.

### BACKGROUND OF THE INVENTION

Today's increasingly digital societies and markets mandate consistent procedures for information access, processing and storage. A recurrent theme is the need for regulatory-compliant storage as an essential underpinning enforcing long-term data retention and life cycle policies.

Conventional compliance storage products and research prototypes are fundamentally vulnerable to faulty or malicious behavior due to a reliance on simple enforcement primitives that are ill suited for their threat model. Tamper-proof processing elements are significantly constrained in both computation ability and memory capacity. Conventional systems for secure maintenance of digital data typically operate on tape-based systems, optical disks and conventional hard disks. Tape-based systems operate on an assumption that only approved readers are used. Keyed checksums are written onto the tape and keys are managed inside the specific reader. Optical disks are relatively high cost, require a relatively large amount of space, do not allow for secure deletion and are subject to replication attacks. Existing hard disk-based systems suffer from the fact that only software programs are deployed to enforce data security. Adversaries with physical access can easily circumvent this, as described below and suffer from a significant problem in regard to a limited number of maximum allowed spatial gate-density due to heat dissipation limitations.

A conventional storage system is described in U.S. Pat. No. 6,879,454 to Winarski et al., the disclosure of which is incorporated herein by reference. Winarski et al. discloses a disk-based WORM system whose drives selectively and permanently disable their write mode by using Programmable Read Only Memory (PROM). In Winarski et al., a PROM fuse is selectively blown in the hard disk drive to prevent further writing to a corresponding disk surface in the hard disk drive. A second method of use employs selectively blowing a PROM fuse in processor-accessible memory, to prevent further writing to a section of Logical Block Addresses (LBAs) corresponding to a respective set of data sectors. However, conventional methods such as the method of Winarski et al. fail to provide strong WORM guarantees.

Using off-the-shelf resources, an insider can penetrate storage medium enclosures to access the underlying data, as well as any flash-based checksum storage. This allows for surreptitious replacement of a device by copying an illicitly modified version of the stored data onto an identical replacement unit. Maintaining integrity-authenticating checksums at device or software level does not prevent this attack, due to the lack of tamper resistant storage for keying material. By accessing integrity checksum keys, an adversary can construct a new matching checksum for the modified data on the replacement device, thereby remaining undetected. Even if tamper-resistant storage for keying material is added, a malicious super-user will likely have access to keys while they are in active use.

The system described by Lan Huang, et al. in CIS: Content Immutable Storage for Trustworthy Record Keeping, Proceedings of the Conference on Mass Storage Systems and Technologies (MSST), 2006, assumes that hard disks are hardened enough to defend against a determined insider. This assumption breaks important security and cost considerations of such systems. From a security standpoint, because disks incur a significant rate of failure (mean time between failures)—system administrators (and insiders with physical access) must replace such disks. In the process of doing so, these un-trusted individuals will have the opportunity to replace units with compromising data. From a cost effectiveness point of view, this assumption is impractical, leads to unfeasible systems and violates the desire of having a “small trusted computing base”. Such systems do not respect important data retention semantics by allowing append operations, resulting in the ability of malicious insiders to alter the meaning of stored data after its initial write (e.g., by appending exonerating text to incriminating documents).

In addition, digital societies and markets are increasingly mandating consistency in procedures for accessing, processing and storing digital information. As increasing amounts of digital information are created, stored and manipulated, digital compliance storage is becoming a vital tool in restoring trust and detecting corruption and data abuse. The present invention provides a secure design that is compliant with regulatory schemes.

Recent compliance regulations are intended to foster and restore humans trust in digital information records and, more broadly, in our businesses, hospitals, and educational enterprises. In the United States alone, over 10,000 regulations can be found in financial, life sciences, health-care and government sectors, including the Gramm-Leach-Bliley Act, Health Insurance Portability and Accountability Act, and Sarbanes-Oxley Act. A recurrent theme in these regulations is the need for regulatory-compliant storage as an underpinning to ensure data confidentiality, access integrity and authentication; provide audit trails, guaranteed deletion, and data migration; and deliver WORM assurances, essential for enforcing long-term data retention and life-cycle policies. Unfortunately, current compliance storage WORM mechanisms are fundamentally vulnerable to faulty behavior or insiders with incentives to alter stored data because they rely on simple enforcement primitives such as software and/or hardware device-hosted on/off switches, ill-suited to their target threat model.

The present invention provides a strong, compliant storage system for realistic adversarial settings that deliver guaranteed document retention and deletion, quick lookup, and compliant migration, together with support for litigation holds and several key aspects of data confidentiality.

Further, simply deploying the entirety of traditional data retention software inside trusted hardware modules is ineffective due to the severe computation and storage limitations of such hardware. In conventional systems, a server's main CPUs remains starkly under-utilized and the full processing logic of general-purpose secure coprocessors (SCPUs) is not realized due to lack of performance. The coupling of a fast, un-trusted main CPU and with an expensive slower secured CPU of conventional systems is ineffective. The present invention leverages secure trusted hardware in an efficient manner to achieve strong and practical regulatory compliance for storage systems in realistic adversarial settings.

### SUMMARY OF THE INVENTION

The present invention provides a Write-Once Read-Many (WORM) storage system providing strong assurances of data retention and compliant migration. The present invention leverages trusted secure hardware in close data proximity. The present invention achieves efficiency by ensuring the secure hardware is accessed sparsely, minimizing the associated overhead for expected transaction loads and using adaptive overhead-amortized constructs to enforce WORM semantics while maintaining an ordinary data storage server throughput rate during burst periods. For example, the present invention allows a single secure co-processor running in an off-the-shelf Pentium PC to support over 2500 transactions per second.

In addition, the present invention addresses the need for a data server that provides a defense against malicious insiders having super-user authorities and administrative privileges, and allows for migration between devices, to comply with the decades-long retention periods.

The present invention avoids malicious acts by individuals having super-user powers and direct physical hardware access by use of both tamper-resistant and active processing components. In addition, the present invention prevents a rewriting of history, rather than merely creating a partial memory of data that is no longer available.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 depicts desired prevention of WORM preventing history rewriting;

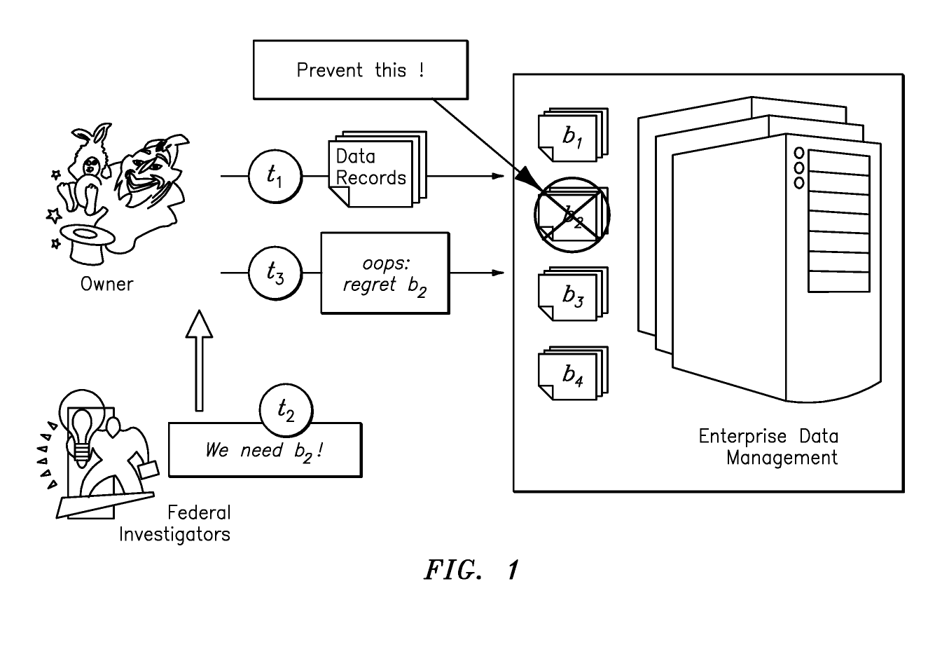

FIG. 2 depicts vulnerabilities of conventional soft-WORM approaches without the support of tamper-proof hardware to adversaries having physical access to a data store;

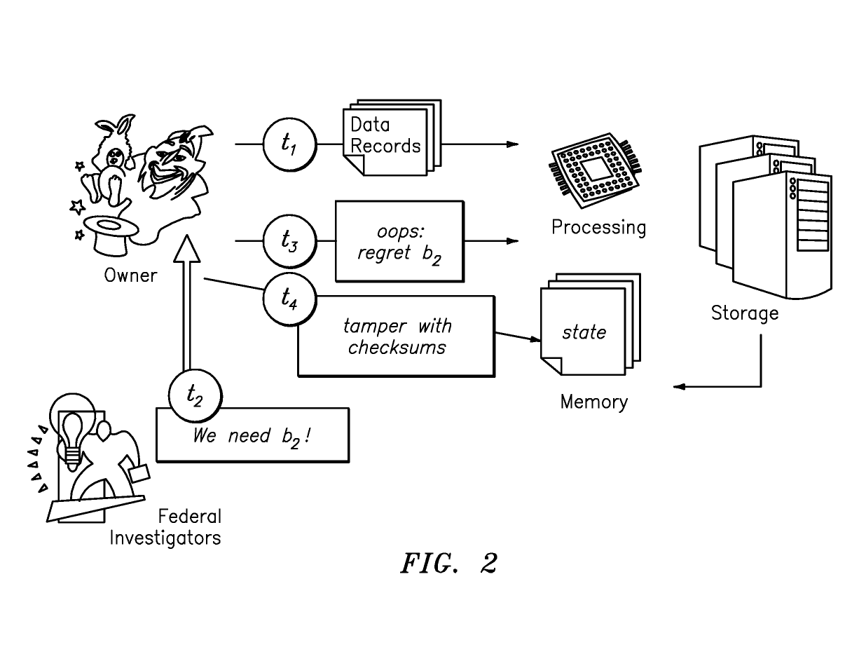

FIG. 3 shows SCPU/CPU cooperation for serial number management of an embodiment of the present invention;

FIG. 4 shows an embodiment of the present invention of SCPU witnesses retention;

FIG. 5(a) shows write duration, with hashing and deferred hashing;

FIG. 5(b) shows write throughput with hashing and deferred hashing;

FIG. 5(c) shows write throughput deferred signatures, with hashing and deferred hashing deferred signatures;

FIG. 6 shows experimental throughput (records/second) variation of the present invention with varying parameters for the database size and an insertion/deletion ratio;

and

FIG. 7 is a flowchart showing operation of the invention.

### DETAILED DESCRIPTION OF THE PREFERRED EMBODIMENTS

The following detailed description of preferred embodiments of the invention will be made in reference to the accompanying drawings. In describing the invention, explanation about related functions or constructions known in the art are omitted for the sake of clearness in understanding the concept of the invention, to avoid obscuring the invention with unnecessary detail.

Reference herein is made to timestamps generated by the SCPU and deployed to assert the freshness of integrity constructs. In this context, the SCPUs maintain internal, accurate clocks protected by their tamper-proof enclosure to preclude the requirement for additional handling of time synchronization attacks by the insider adversary. Specifically, as long as client clocks are relatively accurate (these clocks are not under the control of the server), time synchronization is not an issue. Unless otherwise specified, the term encryption is used to denote any semantically secure (IND-CPA) encryption mechanism, which is not an inherent requirement of the invention. In the absence of reliable time synchronization, traditional or new mechanisms for time synchronization can be deployed.

As used herein, guaranteed retention refers to a compliance storage system wherein data, once written, can not be undetectably altered or deleted before the end of a predetermined, typically regulation-mandated, life span for the data, even with physical access to the storage medium. Secure deletion refers to deletion of a computer record once the record reaches the end of its lifespan. Once the record reaches the end of its lifespan, the record can—and often must—be deleted. Deleted records should not be and are not recoverable, even by persons having unrestricted access to the underlying storage medium. Moreover, deletion should not leave any hints at the storage server of the prior existence of the record.

Data record refers to any data item, potentially governed by storage-specific regulation. Data records are application specific and can be files, inodes, database tuples, etc. In this system records are identified by descriptors (RDs). A Virtual Record (VR) basically groups a collection of records that fall under the same regulation specific requirements (e.g., identical retention period) and need to be handled together. VRs are allowed to overlap, and records can be part of multiple different VRs (being referenced through different descriptors). This enables a greater flexibility and increased expressiveness for retention policies, while allowing repeatedly stored objects (such as popular email attachments) to potentially be stored only once.

A Virtual Record Descriptor (VRD) is a unique, securely issued identifier for a VR. A preferred VR structure is outlined in Table I below. A VRD is uniquely identified by a securely issued system-wide serial number (SN), and contains various retention-policy related attributes (attr), a list of physical data record descriptors (RDL) for the associated VR data records, and two trusted signatures (metasig and datasig) issued securely (e.g., by the trusted hardware (SCPU)), authenticating the attr and RDL fields. A Virtual Record Descriptor Table (VRDT) is a table of VRDs indexed by their corresponding SNs maintained by the main (untrusted) CPU on disk.

To defend against insiders, the present invention utilizes tamper-resistant active hardware, such as general-purpose trustworthy hardware. One instance of such hardware is the IBM 4764 secure co-processor. Having the ability to run logic within a secured enclosure, allows for building of trust chains spanning un-trusted and possibly hostile environments. The trusted hardware will run portions of the algorithms in this invention. Close proximity to data coupled with tamper-resistance guarantees allow an optimal balancing and partial decoupling of the efficiency/security trade-off. The present invention provides assurances that are both efficient and secure, overcoming practical limitations of trusted devices such as heat dissipation concerns.

This invention relies on the existence of traditional cryptographic hashes and signature mechanisms. Preferred embodiments consider ideal, collision-free hashes and strongly unforgeable signatures. Sₖ(d1,d2,d3 . . . ) denotes a signature with key k on data items d1,d2,d3, . . . combined in a secure manner. Similarly, hash(d1,d2,d3, . . . ) denotes a cryptographic hash function applied to data items d1,d2,d3 . . . combined in a secure manner. However, the approaches discussed here do not depend on any specific instance thereof.

Merkle (hash) trees enable the authentication of item sets by using only a small amount of information. In the hash tree corresponding to data items S={x₁ . . . , xₙ}, each node is a cryptographic hash of the concatenation (or other combination) of its children. The tree is constructed bottom-up, starting with cryptographic hashes of the leaves. The verifying party stores the root of the tree or otherwise authenticates it. To later verify that an item x belongs to S, all the siblings of the nodes in the path from x to the root are sufficient in reconstructing the root value and comparing it with the authenticated root value. The strength of this authentication mechanism lies in the above-mentioned properties of the cryptographic hashes. Merkle trees offer a computation-storage trade-off: the small size of the information that is kept at the authenticator's site is balanced by the additional computation (hashing log n items) and communication overheads. As suggested in the data outsourcing literature (where the adversary is an outsider), Merkle trees are a useful tool to guarantee data integrity. However, in a compliance storage environment, where new records are constantly being added to the store, Merkle tree updates (O(log n) costs) can be a performance bottleneck. The present invention solution overcomes this by deploying a simple yet efficient range authentication technique relying on certifying entire “windows” of allocated records (with O(1) update costs).

Sample deployment environments can include a traditional storage subsystem that contains enterprise disk arrays, typically hosted within multiple physical racks, and a set of multi-CPU interconnected servers. For example IBM System Storage DS4200 Express Model 7V disk storage system and IBM System x3755 are representative two components.

To enforce strong WORM semantics, in this invention, the servers are augmented with trusted hardware components (e.g., FIPS 140-2 Level 4 certified) as main points of processing trust and tamper-proof assurances. The preferred architecture employs general-purpose trusted hardware such as the IBM 4758 PCI and IBM 4764 PCI-X cryptographic coprocessors. The IBM 4764 is PowerPC-based and runs embedded Linux. The 4758 is based on a Intel 486 architecture, preloaded with a compact runtime environment that allows the loading of arbitrary external certified code. The CPUs are custom programmable and 4758 compatible with the IBM Common Cryptographic Architecture (CCA) API. See, IBM Common Cryptographic Architecture (CCA) API, www-03.ibm.com/security/cryptocards//pcixcc/overcca.shtml.

The CCA implements cryptographic services such as random number generation, key management, digital signatures, and encryption (DES/3DES,RSA). If physically attacked, the devices destroy internal state (in a process powered by internal long-term batteries) and shut down in accordance with the FIPS 140-2 certification. Critical portions of the mechanisms and algorithms described in this patent are hosted and run inside the trusted enclosure and benefit from its assurances against physical compromise by adversaries. However, these CPUs have limited computation ability and memory capacity, due to the inability to dissipate heat from inside a tamper-proof enclosure—making them orders of magnitude slower than ordinary CPUs. Table I below provides a hardware performance overview. The SCPU in this preferred embodiment is an IBM 4764-001 PCI-X, roughly one order of magnitude slower for general purpose computation than main CPUs such as an Intel PENTIUM 4, 3.4 GHZ, OPENSSL 0.9.7F. Therefore such hardware is used only as a severely constrained aide. On the other hand, the crypto acceleration in the SCPU results in faster crypto operations. Also, certain embodiments might yield optimized key setups that result in slightly different numbers than for the main CPU.

TABLE 1

| | | | |
|---|---|---|---|
| Function | Context | IBM 4764 | P4 @ 3.4 Ghz |

| | | | | | |
|---|---|---|---|---|---|
| RSA sig. | 512 | bits | 4200/s | (est.) | 1315/s |
| | 1024 | bits | 848/s | | 261/s |

| | | | |
|---|---|---|---|
| 2048 | bits | 316-470/s | 43/s |

| | | | | | |
|---|---|---|---|---|---|
| RSA verif. | 512 | bits | 6200/s | (est.) | 16000/s |

| | | | |
|---|---|---|---|
| 1024 | bits | 1157-1242/s | 5324/s |
| 2048 | bits | 976-1087/s | 1613/s |

| SHA-1 | 1 | KB blk. | 1.42 | MB/s | 80 | MB/s |
|---|---|---|---|---|---|---|
| | 64 | KB blk. | 18.6 | MB/s | 120+ | MB/s |
| | 1 | MB blk. | 21-24 | MB/s | | |
| DMA xfer | end-to-end | | 75-90 | MB/s | 1+ | GB/s |
| CPU freq | | | 266 | MHz | 3400 | Mhz |
| RAM | | | 16-128 | MB | 2-4 | GB |

A preferred embodiment of the present invention achieves strongly compliant storage in adversarial settings by deploying tamper-resistant, general-purpose trustworthy hardware, running portions of the mechanisms described here. As heat-dissipation concerns greatly limit the performance of such tamper-resistant secure processors (SCPUs), these mechanisms are designed to minimize cost and improve efficiency. Specifically, we ensure the access to secure hardware is sparse, to minimize the SCPU overhead for expected transaction loads. Special deferred-signature schemes, as described in detail herein, are deployed to enforce data retention (WORM) semantics at the target throughput rate of the storage server's main processors.

Further to the overall general philosophy outlined by Huang et al. the following principles are incorporated: increasing the cost and conspicuity of any attack against the system, focusing on end-to-end trust, rather than single components, using a small trusted computing base, isolating trust-critical modules and making them simple, verifiable and correct, using a simple, well defined interface between trusted and untrusted components, and trusting, but verifying every component and operation.

It is important for the record-level WORM layer to be simple and efficient. Thus, the focus on the implementation is on record-level logic. Name spaces, indexing or content addressing can be layered conveniently on top, and mechanisms discussed here can be layered at arbitrary points in a storage stack. In most implementations placement is either inside a file system (records being files, VRDs acting effectively as file descriptors), or inside a block-level storage device interface (e.g., for specialized, embedded scenarios with no namespaces or indexing constraints). Table II provides an outline of a VRD.

TABLE II

| Field | Description |
|---|---|
| SN | A system-wide unique 64-80 bit serial number. |
| attr | WORM-related attributes, including creation |
| | time, retention period, applicable regulation |
| | policy, shredding algorithm, litigation hold, |
| | f_flag, MAC, DAC attributes |
| RDL | The Record Descriptor List - a list of physical |
| | data record descriptors corresponding to |
| | the current VR {RD₁, RD₂, . . .}. |
| metasig | SCPU signature on (SN, attr): Sₛ (SN, attr). |
| datasig | SCPU signature on SN and a chained hash |
| | (or other incremental secure hashing [73, 74]) |
| | of the data records: Sₛ (SN, Hash (data)). |

Table III below provides a WORM interface outline.

TABLE III

| Function | Description |
|---|---|
| write(data,ret,pol,shr) | Writes data record, associated with given |
| returns: new VRD | retention, policy and shredding algorithm. |
| assoc(rd[ ],ret,pol,shr) | Associates set existing RDs under given |
| returns: new VRD | retention, policy and shredding algorithm. |
| read(sn) | Reads from an existing VR. |
| delete(data,serial) | Internal access point used by the SCPU to |
| | delete a VR. Not available to clients. |
| lit_hold(sn,C) | Notifies of a litigation hold to be set on |
| returns: VRD | a VR. This can only be invoked by |
| | authorized regulatory parties with trusted |
| | credential: C = S_{reg}(sn\|current_time) |
| lit_release(sn,C) | Release a previously held litigation lock. |
| | Can only be invoked by the regulatory |
| | party owning it. |

The present invention exploits a small trusted computing base, with the SCPU used as a trusted witness to any regulated data updates (i.e., writes and deletions). As such, the SCPU is involved in updates only but not in reads, thus minimizing the overhead for a query load dominated by read queries.

The SCPU witnessing is designed to allow the main CPU to solely handle reads while providing full WORM assurances to clients (who only need to trust the SCPU). Specifically, upon reading a regulated data block, clients are offered SCPU-certified assurances that (i) the block was not tampered with, if the read is successful, or, if the read fails, either (ii) the block was deleted according to its retention policy, or (iii) it never existed in this store.

In a preferred embodiment there is no hash-tree authentication. To escape the O(log(n)) per update cost of the straightforward choice of deploying Merkle trees in data authentication, we introduce a novel mechanism with identical assurances but constant cost per update. To achieve this, we label data blocks with monotonically increasing consecutive serial numbers and then introduce a concept of sliding “windows” that can now be authenticated with constant costs (O(1)) by only signing their boundaries, due to their (consecutive) monotonicity (vs. deploying Merkle trees with a O(log(n)) cost). In doing so some Merkle-tree expressiveness this not required is lost, namely the ability to handle arbitrary (non-numeric) labels.

In the present invention, peak performance is obtained during high system-load periods. To further increase throughput, expensive witnessing operations (e.g., 1024-bit signatures) are temporarily deferred by deploying less expensive short-term secure variants (e.g., on 512-bit). Thus security is adaptive and ensures that the system can strengthen these weaker constructs later, during decreased load periods, but within their security lifetime. Thus, the protocols adaptively amortize costs over time and gracefully handle high-load update bursts.

In the present invention, the VRDT structure of the untrusted main CPU maintains (on disk) a table of VRDs (VRDT) indexed by their corresponding serial numbers. These serial numbers are issued by the SCPU at each update. The SCPU securely maintains two private signature keys, s and d, respectively, that can be verified by WORM data clients. Their corresponding public key certificates—signed by a regulatory or certificate authority—are made available to clients by the main CPU.

The SCPU deploys s for the metasig and datasig signatures in the VRD and d to provide deletion “proofs” that the main CPU can present to clients later requesting specific deleted records. Specifically, when the retention period for a record v expires, in the absence of litigation holds, its corresponding entry in the VRDT is replaced by S_{d}(v.SN). A VR v can be in one of two mutually exclusive states:
1) active: data records and attribute integrity is enforced by the metasig=Ss(SN, attr) and datasig=Ss(SN, hash(data)) signatures, or
2) expired: with the associated “deletion proof” signature S_{d}(v.SN) present in the VRDT.

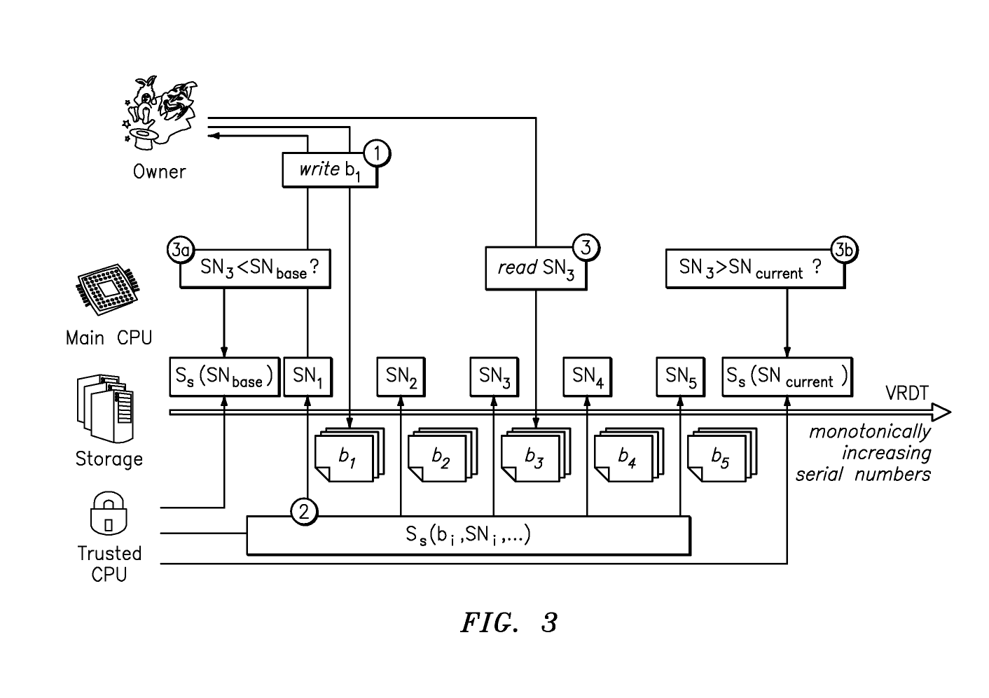

Thus, the VRDT entries contain either the VRD for active VRs, or the signed serial number for records whose retention periods have expired, as shown in FIG. 3, which shows an SCPU cooperating with the main CPU for serial number management. In FIG. 3, the VRDT entries contain monotonically increasing consecutive serial numbers within a specific window: {SN_{base}, SN_{current}}. Any SNₛ outside this range have undoubtedly expired and have been deleted (or are not allocated yet) to limit the VRDT's storage footprint. A trusted signature Ss certifies the unique SN-to-record associations.

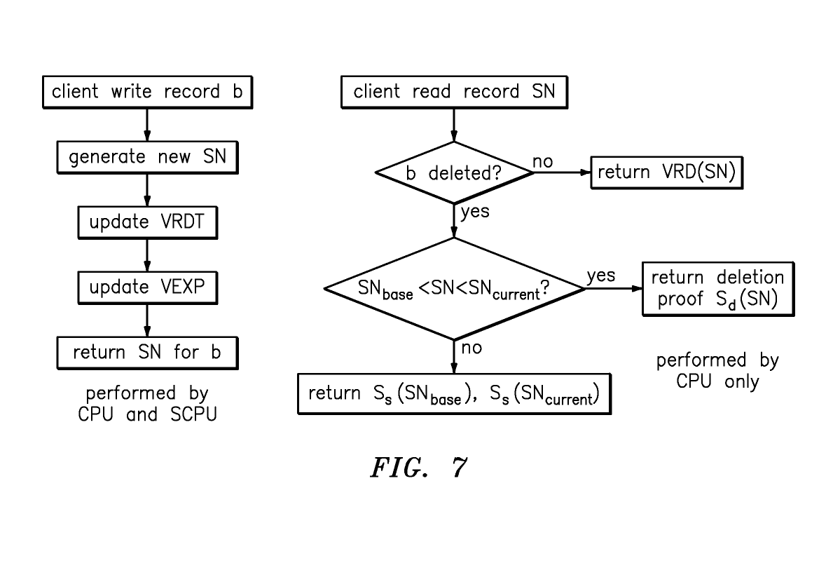

In the present invention, window management is performed by serial number issuing and VRDT management to minimize the VRDT-related storage. A sliding window mechanism is used through which previously expired record deletion proofs can be safely expelled and replaced with a securely signed lower window bound. To address the fact that while some of retention expirations are likely to occur in the order of insertion, this is unlikely to hold for all records, an additional data structure controlling record expiration will be introduced later. Specifically, the lowest serial number among all the still active VRs (whose retention period has not passed and/or have a litigation hold) is denoted as SN_{base}. SN_{current} is set as the highest currently assigned SN. Then, the window defined by these two values contain all the active VRs (and possibly a few already expired ones). Any deletion proofs outside of this window are not of WORM-interest any more, and can be securely discarded. Now the main CPU can convince clients that any of the records outside of the current windows have been rightfully deleted (or have not been allocated yet) by simply providing Sₛ(SN_{base}) and Sₛ(SN_{current}) as proofs. FIG. 7 is a flowchart showing operation of the invention.

In order to prevent the main CPU to use old Sₛ(SN_{current}) values to maliciously ignore recently added records, one of two mechanisms need to be applied: (i) upon each access, the client contacts the SCPU directly to retrieve the current Sₛ(SN_{current}), or (ii) Sₛ(SN_{current}) will also contain a timestamp and the client will not accept values older than a few minutes—and the SCPU will update the signature timestamps on disk every few minutes (even in the absence of data updates). In general cases, it is preferred that (ii) is chosen for the following reasons: in a busy data store, the staleness of the timestamp on Sₛ(SN_{current}) is not an issue, due to the continuously occurring updates; on the other hand, in an idle system, the small overhead of a signature every few minutes does not impact the overall throughput.

To reduce storage requirements, a similar technique can be applied further for different expiration behaviors. Specifically, if records do not expire in the order of their insertion—likely if the same store is used with data governed by different regulations—the following convention is defined: the main CPU will be allowed to replace any contiguous VRDT segment of three (3) or more expired VRs with SCPU signatures on the upper and lower bounds of this deletion “window” defined by the expired SNs segment. This in effect enables multiple active “windows,” linked by these signed lower/upper bound pairs for the deleted “windows.” Since the trusted signatures result in additional SCPU overhead, these storage reduction techniques are deployed during idle periods. It is important to note that the upper and lower deletion window bounds will need to be correlated, e.g., by associating the same unique random window ID to both (e.g., inside the signature envelope). This correlation prevents the main CPU to combine two unrelated window bounds and thus in effect construct arbitrary windows. Also, in order to avoid replay attacks of old Sₛ(SN_{base}) signatures they will include expiration times. Moreover, such replays would not achieve much, as the clients have always the option to re-verify the correct record retention upon read.

In the present invention, retention policy conflict resolution mechanisms are provided—since data records are allowed to participate in multiple VRs. That is, it is important to decide what happens if a record falls under the incidence of two different, potentially contradicting policies. In the WORM layer, where the main concern lies with securing retention policy behavior, the conflicts to be handled are likely the result of different associated expiration times. For such conflicts, several solutions are available: (i) do not allow the same data record to participate in multiple VRs (use copies thereof instead), or (ii) resolve the policy conflict according to predefined conventions.

When resolving the policy conflict according to predefined conventions, the pre-defined convention should relate to the interpretation of the specific conflicting regulations. One alternative could be to simply always delete the record at its earliest mandated expiration time. Another alternative is to force the record's retention until its last occurring expiration. The latter can be enforced by associating each data record securely with a reference count of how many VRD are “pointing” to it, and erasing from media only when the reference count is zero. The implementation of such an association however, is non-trivial. A data structure similar in function to the VRDT will preferably is maintained for the reference counters of each record.

In regard to WORM Operations, for a Write operation, the following operations are executed. The main CPU writes the actual data to the disk, and messages the SCPU with the resulting RDs and the corresponding attributes (such as regulation policy, retention period and shredding method parameters). Data records and their RD descriptors are implementation specific and can be inodes, file descriptors, or database tuples.

The SCPU increments a current serial number counter to allocate a SN value for this new VR and then generates its metasig and datasig signatures. To create datasig the SCPU is required to read the data associated with the stored record. The below discussion of optimization describes how to reduce this overhead at burst-periods under a slightly weaker security model (the main CPU will be trusted to provide datasig's hash; the hash will be verified during idle times). The evaluation performed in preferred embodiments of the present invention considers both models. Next, the main CPU creates a VRD, associates it with the specified attributes, as well as datasig and metasig, both provided by the SCPU. The VRD is then written by the main CPU to the VRDT maintained in unsecured storage.

In preferred embodiments, the present invention performs a read operation by providing a record handle (i.e., the SN) to the WORM layer. A client's read operation only requires main CPU cycles. This is important, as query loads are expected to be often mostly read-only. If a read of a VR v is disallowed on grounds of expired retention, the main CPU will then either provide S_{d}(v.SN) (proof of deletion), or prove that the serial number of v is less than SN_{base} (thus rightfully deleted) by providing Sₛ(SN_{base}). Similarly, in the multiple “windows” solution, discussed above, the main CPU will need to provide a SCPU-signed lower and upper bounds for the window of expired SNs that contains v, as proof of v's deletion. In a successful read the client receives a VRD and the data. It then has the option of verifying the SCPU datasig and metasig signatures. The data client must have access to appropriate SCPU public key certificates that the main CPU in the data server can provide.

If the signatures do not match, the client is assured that the data (or the corresponding VRD) has been prepensely modified or deleted. This is so because the (consecutive) monotonicity of the serial numbers allow efficient discovery of discrepancies.

In the present invention a record expiration function is performed in preferred embodiments. Record expiration and subsequent deletion thereof is controlled by a specialized Retention Monitor (RM) daemon running inside the SCPU. To amortize linear scans of the VRDT while ensuring timely deletion of records, the SCPU maintains a sorted (on expiration times) list of serial numbers (VEXP), subject to secure storage space. The VEXP is updated during light load periods (e.g., night-time). As common retention rates are of the order of years, we expect this to not add any additional overhead in practice (alternatives to this assumption are discussed below). The VEXP is deployed by the SCPU-hosted RM to enable efficient and timely deletion of records. To this end, in one preferred embodiment, the RM is designed to wake up according to the next expiring entry in VEXP and invokes the delete operation on this entry. It then sets a wake-up alarm for the next expiration time and performs a sleep operation to minimize the SCPU processing load. If a new record with an earlier expiration time is written in the meantime, the SCPU resets the alarm timer to this new expiration time and updates the VEXP accordingly. To delete a record, the SCPU first invokes storage media-related data shredding algorithms for v (not discussed). It then provides the main CPU with S_{d}(v.SN), the proof of v's rightful deletion of, which will replace v's entry in the VRDT. The main CPU can then show this signature as proof of rightful deletion to clients.

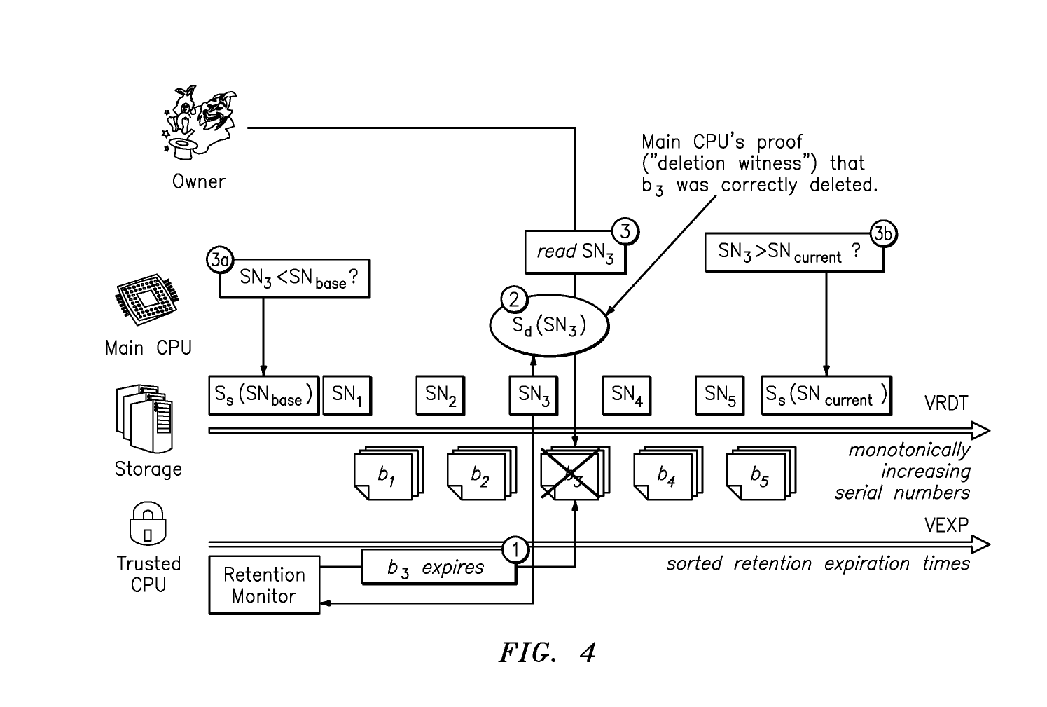

As show in FIG. 4, the SCPU 110 witnesses retention expiration events and provides an unforgeable proof of deletion (the signature S_{d}(SN)) to main CPU 105 to present for future read queries if necessary. The SCPU 110 maintains a sorted list (VEXP) of next-to-expire SNs and runs a Retention Monitor (RM) 120 to ensure timely deletion of records.

In regard to litigation, records involved in ongoing litigation proceedings will often reside in active WORM repositories. A court mandated litigation hold on such active records must prevent record deletion, even if mandated retention periods have expired. That is, expired records cannot be deleted until there is a litigation hold release. This is achieved through the litigation hold and litigation release entry-points. Both operations will alter the attr field to set a litigation held flag together with an associated timeout of the hold. This process will be performed by the SCPU, who will subsequently also update metasig. Litigation holds can be set only by authorized parties identified with appropriate credentials. In their simplest form, these credentials can be instantiated as a verifiable regulation authority signature on the record's SN, the current time stamp C=S_{reg}(SN, current time) (and an optional litigation identifier). This signature can be stored as part of the attr field, e.g., to allow the removal of the hold by the same authority only (or other similar semantics). This will be achieved by invoking a litigation release.

Of note regarding failures and operation atomicity, in all of the above operations, failures in timely updates to the disk-hosted data structures (e.g., the VRDT) can impact the WORM semantics and leave the store in an inconsistent state. For example, apparently, failures in the deletion process could cause records to be physically deleted before their corresponding deletion proofs have been generated. To handle such failures, the recovery process will be carefully designed, e.g., to explore the entries in the VRDT and reconcile them with the records in the VEXP, ensuring deletion proofs will be generated (upon recovery) for all expired records.

In regard to migration, in long-lived data scenarios, it is important to enable the migration of data to newer hardware and infrastructures while preserving regulation specific assurances. The present invention provides a mechanism to allow the secure transfer of secure WORM-related state maintained by the SCPU (together with the underlying data) to a new data store, under the control of its untrusted operator. The present invention minimally involves regulatory authorities yet preserves full security assurances in the migration process. The main challenges are related to the creation of a secure trust chain spanning untrusted principals and networks. Specifically, the original SCPU (Secure CPU, referred to as SCPU₁ in this embodiment) should be provided assurances that the migration target environment (SCPU₂) is secure and endorsed by the relevant regulatory authority (RA).

To achieve the above, the migration process is initiated by (i) the system operator retrieving a Migration Certificate (MC) from the RA. The MC is in effect a signature on a message containing the time stamped identities of SCPU₁ and SCPU₂. Upon migration, (ii) the MC is presented to SCPU₁ (and possibly SCPU₂), who authenticates the signature of the RA. If this succeeds, SCPU₁ is ready to (iii) mutually authenticate and perform a key exchange with SCPU₂, using their internally stored key pairs and certificates. The SCPU₂ has backwards-compatible authentication capabilities, as the default authentication mechanisms of SCPU₂ may be unknown to SCPU₁. This backwards compatibility is readily achievable as long as the participating certificate authorities (i.e., SCPU manufacturer or delegates thereof) still exist and have not been compromised yet. A cross-certification chain is in a preferred embodiment set up between the old and the new certification authority root certificates. Once (iii) succeeds, SCPU₁ will be ready and willing to transfer WORM and indexing state on a secure channel provided by an agreed-upon symmetric key (e.g., using a Diffie-Hellman variant). After the secure state migration is performed, main data records can be transferred by the main CPUs directly.

The migration process is preferably controlled by an externally run user-land Compliant Migration Manager (CMM). The CMM is configured to interact with the RA and the certificate authorities, create the communication channels between the data migration source and target systems, and perform and monitor the raw data transfer between data stores once the inter-SCPU interaction is completed.

Optimizations of the present invention include as follows.

In the present invention, SCPU hashing overhead is limited. In the process of creating a VR datasig signature, the SCPU is required to read and hash the data records associated with the VR. As mentioned in regard to the WORM operation discussion above, to support higher burst-periods throughputs, the present invention can reduce this overhead while only minimally impacting the adversarial model assumptions. Specifically, in the present model, if a user “Alice” is trusted to accurately provide the data to be stored—only later does Alice regret the storage of certain records. Accordingly, this assumption is extended by trusting the main CPU (during high-load periods when no SCPU cycles are available) to accurately compute (on behalf of the SCPU) the data hash required in datasig. The trust however, is not blind. Rather, the SCPU verifies this trust assumption by re-computing and checking these hash values during lower-load times (e.g., when the update burst is over) or after a certain pre-defined timeout.

This extension does not weaken the WORM defenses significantly, because providing an incorrect hash will be detected immediately upon verification, and the window of time between record commitment and hash verification can be kept insignificant in comparison to typical year-long retention rates. A discussion of performance gains achieved by deploying this scheme is provided below.

In the presenting invention, deferring of strong constructs is also provided as a novel alternative to handling high burst periods. Specifically, the deployed throughput optimization method temporarily defers expensive witnessing operations (e.g., 1024-bit signatures) by using less expensive (faster) temporary short-term secure variants (e.g., on 512-bit). This is particularly important during update burst periods. The short-lived signatures will then be strengthened (e.g., by resigning with strong keys) during decreased load periods—but within their security lifetime. In effect this optimization amortizes SCPU loads over time and thus gracefully handles high-load update bursts. The present invention uses in a preferred embodiment 512-bit RSA signatures as a reference security lower-bound baseline. 512-bit composites could be factored with several hundred computers in about 2 months around year 2000. The preferred embodiment assumes that 512-bit composites resist no more than a few tens of minutes (e.g., 60-180 minutes) of factoring attempts by Alice, who may want to do so in order to alter the metasig and datasig fields. We note that in the WORM adversarial model however, this can only rarely be of concern, as Alice is unlikely to regret record storage and succeed in breaking the signatures in such a short time. Deployment of fast shorter-lived signatures during burst periods can in certain embodiment support high transaction rates. To achieve an adaptive behavior, optimally balancing the performance-security trade-off, a determination of maximum signature strength (e.g., bit-length of key) for a given throughput update rate is made, to understand how much faster a signature of x bits is, given as known baseline the time taken by an n bit signature.

Preferred embodiments of the present invention also allow faster alternatives to the above optimization by replacing short-lived signatures with simple and fast keyed message authentication codes (e.g., HMACs). This practically removes any authentication bottlenecks during burst periods, thus allowing practically unlimited throughputs at levels only restricted by the SCPU—main memory bus speeds (e.g., 100-1000M B/s). The only drawback of this method is the inability of clients to verify any of the HMAC'ed committed records until they are effectively signed by the SCPU. A preferred embodiment of the present presents the HMACs production environment as the prevalent design choice.

The present invention provides efficient record expiration support structures. As discussed above, to ensure timely deletion of expired records, a sorted list of SNs for records in order of their expiration times is maintained in a special linear data structure(VEXP) inside the SCPU. Naturally, due to memory limitations, the VEXP may not hold the SNs for the whole database.

So far we considered a solution in which the VEXP is sufficiently large to keep up with the data specific regulation-mandated expiration rates. As discussed above, the VEXP is updated with fresh entries from the VRDT in times of light load (a scan of the VRDT is required to do so), i.e. a “VEXP” solution. While it is believed this is a reasonable assumption—especially given the year-long retention periods that are usually mandated—discussed below are situations when the expiration rate is high enough to deplete the VEXP data structure before “light load” times come around. Specifically, when depleted, the SCPU will have to suspend other jobs and scan the VRDT to replenish the VEXP. But linear scanning of the VRDT may be expensive due to the fact that records do not appear in the order of their expiration times. Thus, additional solutions are required to enforce more efficient deletion mechanisms.

In addition to updating the VEXP during light load periods, the present invention provides two alternative solutions, a first maintains an authenticated B-Tree index (in un-trusted storage)—instead of a SCPU-internal, limited size VEXP structure- sorting the entries in the VRDT in their increasing expiration times. The retention monitor (RM) running inside the SCPU will simply check the B-Tree to determine the records that are to be expired next. The B-Tree will be updated in the write operation at the same time as the VRDT. It will be authenticated by simply maintaining a hash-tree on top of it, enforcing its authenticity and structural integrity assurances as in the verifiable B-trees. Thus, when the VEXP empties, the SCPU can replenish it with a sorted list of SNs by just reading in the corresponding B-Tree leaves. This is referred to as the “pre-sorted” expiration handling solution.

Further, instead of updating the B-Tree for every record insertion, an update buffer can be deployed to reduce the update overhead during bursts. The buffer is used to amortize the cost for each update by buffering the insertions and committing them to the B-Tree in batches. Specifically, the buffer is used to cache the incoming write updates (to avoid the direct B-Tree update cost in real time). Then, periodically, the elements in the buffer are inserted in the B-Tree by bulk-loading. This is likely to yield significant benefits because a majority of incoming records are likely to not be expiring anytime soon, thus buffering wait-times are not a problem. Ultimately, using a buffer provides an advantage of obtaining high instantaneous throughput in insertion burst periods while keeping the amortized performance roughly the same as the pre-sorted solution. To authenticate the buffer, a simple signed cryptographic hash chain checksum is deployed that enables the SCPU to verify the buffer's integrity upon read. This is important to prevent the server from surreptitiously removing entries from the buffer before the SCPU had a chance to empty it into the B-tree by bulk-loading. This is referred to as “pre-sorted with buffering” solution.

The following discussion is provided regarding evaluation of the above-described embodiments of the present invention. The architecture described above satisfies important WORM assurances of data integrity and non-repudiation.

As a first theorem, data records committed to WORM storage cannot be altered or removed undetected, for data integrity. That is, any adversarial attempt to delete or modify the data will be detected, since all data modifications are witnessed by the SCPU and signed for securely. The proof then reduces directly to the un-forgeability of the deployed signatures and the non-invertible, collision-free nature of the hashes.

As a second theorem, insiders having super-user powers are unable to ‘hide’ active data records from querying clients by claiming they have expired or were not stored in the first place, i.e. non-repudiation. That is, a claim of deletion needs to be accompanied by a proof thereof. This proof is a strong, unforgeable signature that can only be generated by the SCPU at record expiration. Claiming previously committed records have not been actually stored is prevented by the (consecutive) monotonicity of the SNs.

The present invention provides performance upper bounds, considered in a preferred embodiment in a single-CPU/SCPU system setup consisting of an unsecured main CPU (P4 @ 3.4 GHz) and the IBM 4764-001 PCI-X Cryptographic Coprocessor. Table I sets out several key performance elements of both the SCPU and the P4. The main CPU and storage I/O costs are note discussed and do not pertain to the WORM layer. Rather, the maximum supported transaction rates, in the presence of update witnessing by the SCPU, is focused on. Specifically, in regard to overheads introduced by SCPU data hashing, and the metasig and datasig signatures: datasig overheads are in Equation (1):

T_{datasig}(x)=Tₕ_{_{d}}(x)+Tₛ_{_{d}}+Tᵢₙ_{_{d}}(x)+Tₒᵤₜ_{_{d}} (1)

where x is the size of the data records, T_{hd}(x) represents the hashing time, T_{sd} is the SCPU signature time, and T_{ind}(x) represents the transfer time for the inbound data in the hashing process. The overheads associated with metasig consist mainly in a SCPU signature on the SN and attr fields (<1 KB in size)—approximating the T_{metasig}(x) value with the SCPU signature time. T(x)=T_{datasig}(x)+T_{metasig}(x).

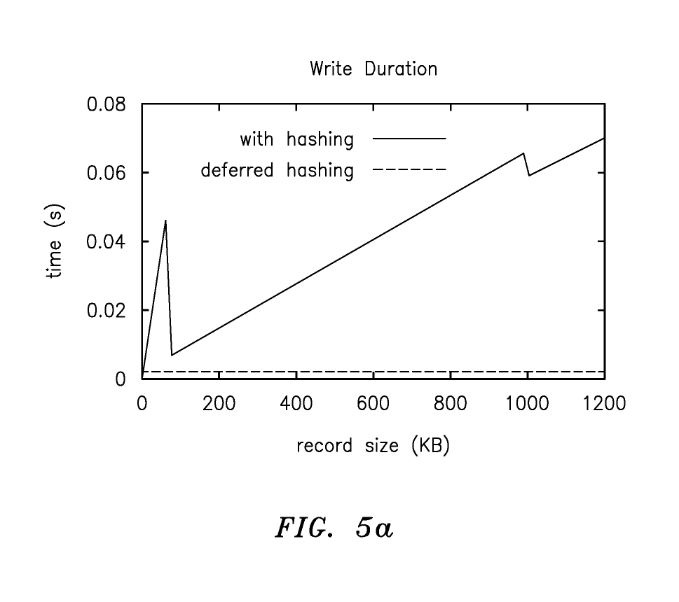

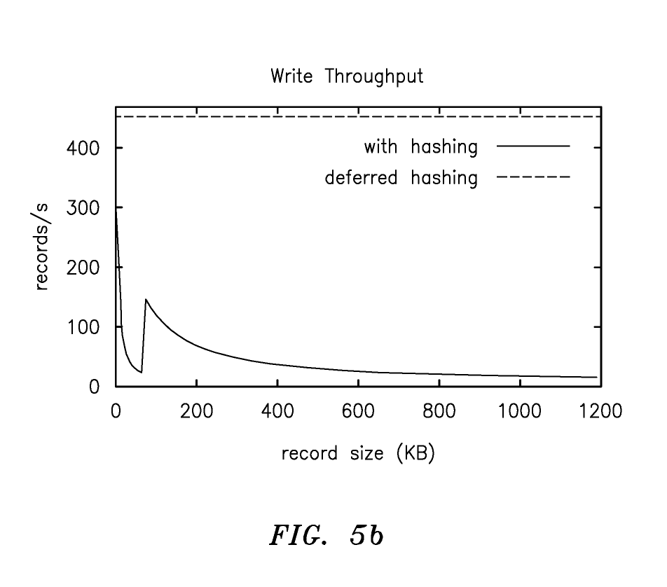

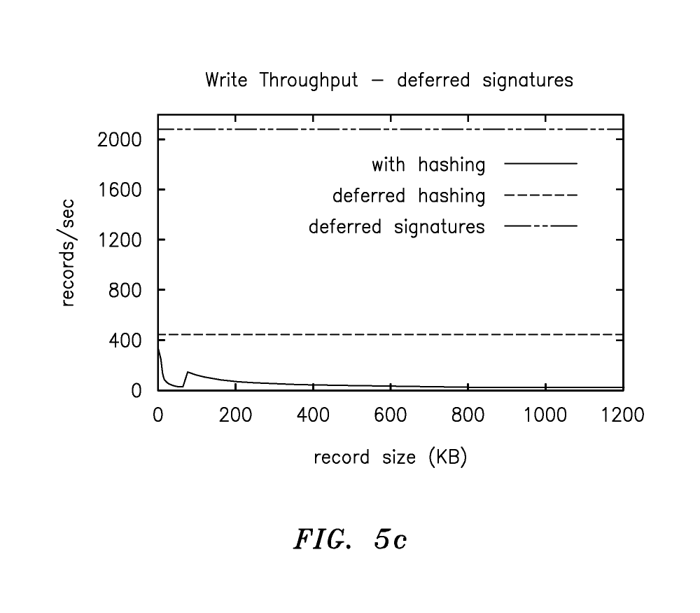

FIG. 5(a) shows a write time variation with record size with partially linear time variation due to hashing and input transfer speed. The optimization method with a deferred data hashing step discussed above results in a 2 ms constant update time regardless of record size. FIG. 5(b) shows throughput variation with record size, with up to 350 updates/sec supported for smaller records. Deferring data hashing obtains a constant throughput of about 400-500 updates/second. FIG. 5(c) shows throughput variation with record size using the deferred strong constructs optimization. Deferred signatures allow significant improvement, reaching 2000-2500 records/s.

In FIG. 5(a) a plot of T(x) is presented for the considered hardware. Due to the hardware nature of the SHA-1 hashing engine we encountered a partially linear variation of writing time, starting at approximately 3 ms for small records of a few KB (300 records/second). The two thresholds at 64 KB and 1 MB-records mark improvements obtained by hashing larger blocks of data. Specifically, the hashed block size is increased from 1024 bits to 64 KB and from 64 KB to 1 MB respectively (see Table I). FIG. 5(a) also depicts the writing time for the optimization method where SCPU hashing costs are deferred. In this case, each write takes no more than 2ms/record (500 records/second). FIG. 5(b) shows throughput as a function of record size.

In FIG. 5(c) it can be seen that the deferred strong constructs optimization yields significant throughput increases. With 512-bit signatures, burst update rates of over 2000-2500 records/second can be sustained for 60-180 minutes (the life-time of the short-lived constructs). As the SCPU is not involved in reads, the only WORM related overhead there is constituted by the optional records signature verification. We note that for normal operation this should not be an issue, as there is no reason why ‘Alice’ should not trust the data store to provide accurate data, or with integrity ensured through cheaper constructs like simple MACs. However, WORM assurances at read time will likely be mandated in auditing scenarios when regulatory parties (e.g., federal investigators) are performing in-house audits. In that case the investigator's clients' hardware, typically commercial x86-level CPU will handle the verification of WORM-related VRDT signatures. Given the figures outlined in Table I, a throughput of over 2500-2600 verified reads per second can be sustained.

In summary, the WORM layer (in a single-SCPU setting) can support per-second update rates of 450-500 in sustained mode, 2000-2500 in bursts of no longer than 60-180 minutes and 2500 reads (sustained). By construction these results naturally scale if multiple SCPUs are available.

For these throughputs it is likely that even for single-CPU (but especially for multi-CPU) systems, I/O seek and transfer overheads are likely to constitute the main operational bottlenecks (and not the WORM layer). Typical high-speed enterprise disks feature 3-4 ms+latencies for individual block disk access. These times are twice the projected average SCPU overheads and can become dominant, especially when considering fragmentation and multi-block record accesses.

Expiration cost evaluation overheads introduced by the three record expiration handling mechanisms, as discussed above, were also analyzed, mainly focused on I/O costs that are likely the main bottle-necks in accessing the externally-stored B-Tree, in contrast to previous discussion exploring the upper bounds of the supported transaction rates.

Costs of the three record expiration-handling solutions are focused on:

(1) In the VEXP solution, the cost for an insertion is just the cost of the write operation T (x) was analyzed above as Equation (2):

T_{VEXP}−ins(x)=T(x)=T_{datasig}(x)+T_{metasig}(x) (2)

When the VEXP is depleted, the SCPU has to linearly scan the VRDT. Thus the amortized cost for a deletion is shown in Equations (3) and (4):

$$\begin{matrix}{T}_{VEXP - del} ( x ) = \frac{{T}_{scan}}{y} & ( 3 ) \\ {T}_{scan} = \frac{VRDT Size}{{disk}_{bw}} + \frac{VRDT Size * {disk}_{frag} * {disk}_{seek}}{{disk}_{blocksize}} & ( 4 )\end{matrix}$$

where T_{scan} is the time-cost of scanning the VRDT, diskfrag is the disk fragmentation rate, disk_{bw}, diskₛₑₑₖ represent the disk bandwidth and seek time respectively and y is the size of VEXP. For simplicity and illustration purposes we assume that the record size is the same as the disk block size (diSk_{blocksize}), corresponding to a deployment inside a block-level device stack.

(2) In the pre-sorted solution, every new record has to be inserted into the B-Tree as well (in addition to the VRDT). The cost for an insertion becomes, as shown in Equation (5):

Tpresorted-ins=Tdatasig+Tmetasig+Tseek+Ttrans+Tupdate (5)

where TreeHeight denotes the height of the B-Tree and Tₛₑₑₖ=diskₛₑₑₖ*TreeHeight is the disk seek time for traveling from the B-Tree root to the leaf level to insert the new entry. The transfer time for reading in the corresponding data blocks is provided by Equations (6) and (7):

$$\begin{matrix}{T}_{trans} = \frac{{disk}_{blocksize} * TreeHeight}{{disk}_{bw}} \\ and & ( 6 ) \\ {T}_{update} = \frac{{disk}_{blocksize} * Tree Height}{HashSpeed} & ( 7 )\end{matrix}$$

is the cost for updating the verifiable portion of the B-Tree (which involves one hash computation per visited node), where HashSpeed denotes the throughput of the deployed cryptographic hash function.

The cost of a deletion consists of the cost of reading in the sorted SNs from the B-Tree leaves (and then inserting them into the VEXP structure), as provided in

Equation (8):

$${T}_{pre \text{-} sorted\_del} = \frac{{T}_{trans\_list} + {T}_{update}}{y} \qquad ( 8 )$$

where Tₜᵣₐₙₛ_{_{—}}ₗᵢₛₜ is the time for populating the VEXP with the read SNs.

For the pre-sorted with buffering solution, compared with the simple pre-sorted solution, there is an additional cost for maintaining the buffer. As a reminder, the buffer is used to cache the incoming write updates (to avoid the direct B-Tree update cost each time). Periodically, the elements in the buffer are inserted in the B-Tree by bulk loading.

A main cost component here lies in simply maintaining the chained hash checksum that enables the SCPU to verify the buffer's integrity upon read, as set forth in Equation (9):

T_{buffer-ins}=T_{presorted-ins}+Tₕₐₛₕ (9)

where Tₕₐₛₕ is a constant time to re-compute the new chained checksum for the newly inserted entry. The cost for a deletion is the same as the simple pre-sorted solution.

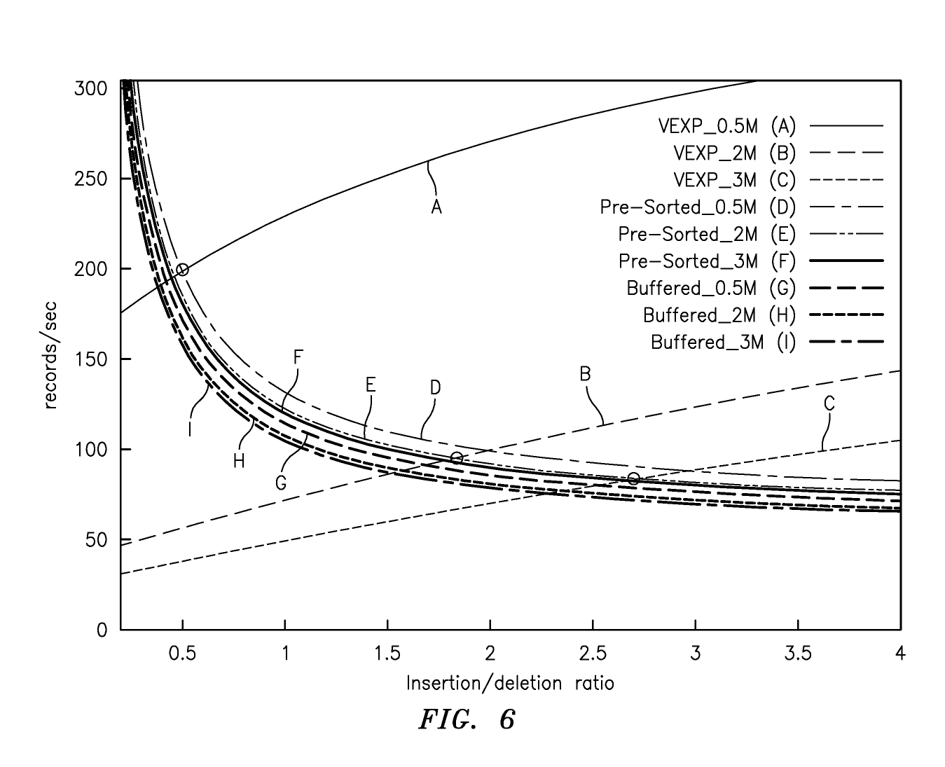

FIG. 6 shows throughput variation, using deferred hashing, with database size and insertion/deletion ratio for database sizes of 0.5M, 2M, and 3M records using hardware parameters of Table I with 4 KB block size, 0.1% disk fragmentation, 2 milliseconds disk seek time.

As depicted in FIG. 6, the impact of the above-described expiration handling solutions in the maximum supported throughput, with the x-axis representing a ratio of record insert to regulation mandated deletion rates, to effectively model a rate growth system rate. If the insertion rate is higher than the corresponding expiration rates, then the effective size of the database is going to increase. The insertion/deletion rate ratio determines how fast this happens.

If the ratio is sub-unitary, the system effectively “empties.” In this case, it can be seen that up to around a ration of 0.5, the pre-sorted methods do better than the VEXP solution. Between 0.5 and approx. 1.7, the VEXP mechanisms perform better but only for smaller database sizes (e.g., 0.5 MB). On the other hand, for 2 MB databases for example, the VEXP curve lies below the pre-sorted curves. Starting from a ratio of 1.7 onwards, the VEXP solutions start to out-perform the pre-sorted variants for database sizes of under 2 MB. At a ratio of around 2.7 this holds also for database sizes over 3 MB.

Naturally, these data points are quite instance and parameter specific, yet the overall behavior shows that as database size grows, the curves of the pre-sorted solutions mostly overlap, indicating little overall influence. On the other hand, the performance of the VEXP solution is dropping largely. The reason for this is the increase in size of the VRDT, thus yielding more expensive scans thereof. Moreover, it can be seen that as the insertion/deletion ratio increases, the throughput of the two pre-sorted solutions decreases while the throughput of the VEXP solution increases. This is because pre-sorted solutions are paying more than the VEXP solution in insertion. In other words, the larger the ratio is, the more efficient it becomes to use the VEXP solution.

The curves for the VEXP solutions and the pre-sorted variants intersect at certain points, depending on the corresponding database sizes. As a result, in a preferred embodiment an adaptive solution for the deployment of an adaptive solution for different insertion/deletion ratios, choosing optimal expiration handling mechanisms as follows. When the ratio is below certain thresholds (which can be regarded as the expiration burst periods) the pre-sorted solutions outperform the VEXP solution. As the ratio increases, VEXP features higher throughputs than the pre-sorted solutions. To prevent oscillations in the adaptive switching right at the threshold, hysteresis mechanisms can be deployed. Moreover, abrupt changes to the average insertion/deletion ratio are unlikely.

While the invention has been shown and described with reference to certain exemplary embodiments of the present invention thereof, it will be understood by those skilled in the art that various changes in form and details may be made therein without departing from the spirit and scope of the present invention as defined by the appended claims and equivalents thereof.

What is claimed is:

1. A method for secure storage of digital information in an adversarial setting, the method comprising:
receiving from a main CPU digital information for storage in the adversarial setting; and
enforcing by trusted hardware receiving the digital information compliance with data storage mandates.

2. The method of claim 1, wherein the trusted hardware is a tamper resistant processor (SCPU).

3. The method of claim 2, further comprising
identifying data retention received by the SCPU from the main CPU; and
sparsely accessing the SCPU based on the prior identified data retention cycles, thereby minimizing secure storage overhead.

4. The method of claim 1, wherein data retention assurances are provided for information stored by a Write-Once Read-Many (WORM) storage system.

5. The method of claim 4, wherein a read operation is performed by providing an SN record handle to the WORM layer.

6. The method of claim 2, further comprising using, during peak data storage periods, adaptive overhead-amortized constructs to maintain data assurances while minimizing a ratio of SCPU size to main CPU size.

7. The method of claim 6, wherein the data retention assurances facilitate migration of the digital information to a replacement SCPU from a legacy SCPU while maintaining data compliance assurances.

8. The method of claim 2, further comprising:
incrementing by the SCPU a current serial number counter to allocate a SN for a new VR; and
generating metasig and datasig signatures corresponding to the serial number counter, wherein the VRD is written by the main CPU to a VRDT maintained in unsecured storage.

9. The method of claim 1, wherein the SCPU is a trusted witness for regulated data updates and the SCPU is not involved in data read updates.
